(19) United States
(12) Patent Application Publication
(10) Pub. No.: US 2003/0180940 A1
(43) Pub. Date: Sep. 25, 2003

(54) Composting apparatus with internal transport system

(76) Inventors: Julian Mark Watson, Canterbury (NZ); Murray Edwin Taylor, Christchurch (NZ); Gillian Helen Worth, Christchurch (NZ); Peter william Robinson, Christchurch (NZ)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 10/362,444

(22) PCT Filed: Aug. 23, 2001
(86) PCT No.: PCT/NZ01/00171

(30) Foreign Application Priority Data
Aug. 23, 2000 (NZ) 505829

(51) Int. Cl. C05F 17/02

(52) U.S. Cl. 435/290.2; 435/290.4

(57) ABSTRACT

A composing system which includes a stationary and usually unheated generally horizontal composting chamber with an inlet and outlet at oposite ends of the chamber. Through the middle of the chamber may be a shaft or shafts to which are attached a series of discrete arms, appendages or flutes that extend into the outer volume of the chamber. The arms mix and agitate a composting material placed in the inlet and transport the compost material to the outlet at the other end of the chamber while the material composts and biodegrades in the chamber. The arms allow air to penetrate into the composting material and to release water through the emission of steam. A number of probes through the exterior of the chamber which extend into the headspace of the chamber, or into the copositing mix measure temperature and carbon dioxide levels with the chamber.

### FIELD OF THE INVENTION

The invention relates to composting and particularly to a composting system for organic and other putrescible waste materials of domestic, commercial, agricultural or industrial origin.

### BACKGROUND OF THE INVENTION

Composting is an aerobic microbiological process by which putrescible organic material is degraded into humus material suitable for use as a soil conditioner, fertiliser or similar product. Adequate air must be supplied to the composting material for this to occur. The heat generated during the process serves to disinfect the material of any pathogens and against germination of most seeds contained within the material.

There are four main types of composting systems that have been devised for commercial purposes, however hybrid systems are also available. The four main systems can be categorised as follows:

A windrow system: this is an open system and the material to be composted is piled in long rows. These are either aerated by forced convection or by frequent turning using a mechanical agitator system.

An enclosed static stack system: air is forced up through a pile of the material to be composted, which is enclosed in some type of vessel. This is a batch process in which the vessel is loaded and unloaded once for each composting cycle.

An agitated bay system: these systems primarily utilise U-shaped channels or bays. Material to be composted is often added semi-continuously and periodically agitated and moved by mechanical means. However, primary aeration is often achieved via forced air movement.

Continuous or semi-continuous in-vessel composting systems: In these systems the material to be composted is fed in one end (side, top or bottom) of the composting system and exits continuously from another.

Numerous examples of the above systems are currently being produced and include the Rotocom™ and the VCU™ systems as well as examples illustrated in “The Practical Handbook of Compost Engineering”, Roger T Haug, Lewis Publishers, 1993 (ISBN 0-87371-373-7).

Rotocom™ (manufactured under licence by ADM Group in New Zealand), Dano, Eweson (Bedminster Bioconversion Corporation), Voest-Alpine and Buhler Inc are all examples of horizontal flow rotary drum systems. These systems are based on a cylinder that rotates around its long axis. The rotation of the cylinder facilitates mixing and aeration, internal flights may move the material along the cylinder.

The VCU™ is a continuous vertical system and is described in Patent Specification No. PCT/NZ98/00107. This unit is similar in principle to other vertical flow, agitated solid bed systems such as those produced by Dambach-Schnorr, Krupp-Varro and NGK. The composting mix is fed in at the top and falls out through a grate at the bottom, aeration can be provided passively or by an extractor or vacuum fan at the top of the stack.

Other systems are based on a stationary cylinder with an internal and fully continuous screw mechanism [JP2000313684, JP7265842 JP7039851]. These either treat the material in a batch or continuous process. Another type of system incorporates a series of central shafts inside a cylinder. From each shaft extend at least two series of fingers, diametrically opposed, that are used to agitate the mix, which is being composted, then dried through the incorporation of hot air in a batch process [U.S. Pat. No. 4,411,682]. A number of systems use either flights about a central shaft or a screw to knead or compress and therefore dewater the material being composted [JP11021191, JP 9077583].

An object of the present invention is to provide an in-vessel, continuous, and generally horizontal composting system, which provides an efficient alternative to existing composting systems.

### SUMMARY OF THE INVENTION

According to a broadest aspect of the invention there is provided a composting system including a stationary and usually unheated generally horizontal composting chamber with an inlet and outlet at opposite ends of the chamber.

The chamber can be of a horizontal generally cylindrical shape or an open channel. If the system is based on an open channel then it has a cover to ensure adequate control of the emission of air from the chamber. Through the middle (this may be on or off-centre) of the chamber may be a shaft or shafts to which are attached a series of discrete arms, appendages or flutes (henceforth referred to simply as arms) that extend into the outer volume of the composting chamber. The geometric placement of the arms and the overall structure being adapted to mix and agitate the composting material placed in the inlet, to allow air to permeate into a composting mix by opening up the structure of the material, and transport the compost material to the outlet at the other end of the chamber while the material composts and biodegrades in the chamber.

The arms and the shaft can be made of metal or plastic or some composite material (e.g. epoxy-fibreglass). Each shaft is supported at each end by means of a bearing in an endplate fixed to the chamber. Each shaft can be supported additionally along the length of the composting system through one or more bearing support mechanisms.

The arms serve to mix the composting mass, to break up any agglomerates in the composting mass, allow air to penetrate into the composting material and to release water through the emission of steam. The arms transport the composting material from one end of the composting chamber to the other while it undergoes an aerobic composting process. The arms may be moved, continuously or discontinuously, in combinations of a clockwise or anticlockwise direction, which aids in mixing and is used to control the residence time of the composting mix within the composting chamber.

According to another aspect of the invention there is provided a composting system including a generally horizontal composting chamber constructed as a covered channel which is fully enclosed or a substantially cylindrical vessel, the chamber being adapted so that air emissions from within the chamber can be controlled, the chamber including an internal transport system which conveys composting material from one end of the chamber to the other in a continuous or batch process, the transport system is based on a generally central shaft, or series of shafts generally about the centre of the chamber which have a series of discrete arms that extend into the outer volume of the chamber, the discrete arms being arranged in a helical fashion about the shaft(s) such that when the shaft(s) are rotated they move the material in one direction or the other along the chamber, depending on the direction of rotation of the shaft(s), the transport system being under the control of a microprocessor based system which records inputs from various probes about the chamber which determine the optimal air speed as a function of the headspace air temperature and carbon dioxide content of the air in the chamber such that the CO₂ content of the air is maintained at an optimum level.

The chamber can be constructed from a single insulating and structurally sound material or from two or more layers of material, at least one of which provides insulation.

The chamber can be unheated and the efficacy of the system relies on controlling the heat naturally produced in the composting process.

The drive system can be an electric motor(s) coupled to a reduction gearbox/es).

The internal transport system is designed so that the appendages serve to mix the incoming composting material, to break up any agglomerates within the material and “fold” air into the composting material.

The composting system can be run as a batch process by filling the chamber and then equalising the movement of the shaft(s) in the opposing directions and by closing off the exit end of the system.

The combinations of movement in opposite directions of the internal transport system serve to control the residence time of the material within the chamber and therefore control the specifications of the material exiting from the system.

The composting system includes a provision for air to be drawn over the mix, in addition to the air introduced into the mix via the transport system, in a direction counter to the general flow of the material to avoid re-infection of the composted material by pathogens contained within the unprocessed feed material and to avoid reintroducing moisture into the composted material from steam being conducted by the airflow.

The chamber can be installed such that the exit end is higher than the inlet end with a minimum gradient of 1:100.

The composting system can include a feed system used to present the material to be composted to the inlet of the chamber and another system used to remove the compost from the exit area of the chamber. The feed system can consist of an auger(s) or conveyor(s). The exit system can be an auger(s) or conveyor(s) or a bin that is regularly emptied via other means.

The composting system can incorporate a number of probes through the exterior of the chamber and extending into the headspace of the chamber, or into the composting mix, in order to measure temperature and carbon dioxide (and other gas) levels within the chamber.

The composting system can be controlled by a microprocessor based system, such as a PLC or computer, with data recording capabilities. The microprocessor based system incorporates software written for the specific purpose which records the input from the various probes about the chamber. The microprocessor can monitor the current of the drive motor(s) to ensure that the torque of the transport system does not exceed the specifications of the transport system and drive mechanism and this system controls the movement and direction of the internal transport system and infeed system to the compost and optionally it can control any exit system used to convey the material away from the chamber.

The microprocessor system can also control the air speed of the air flowing over the composting material by the control of the speed of a fan, or a valve/diaphragm on the air exhaust.

The control system can be operated remotely using software expressly written for the purpose. When the control system is operated remotely via a centralised system, which controls a number of sites, the centralised system can provide feedback on composting conditions to operators and it can, using software expressly written for the purpose, use the parameters recorded from the chamber(s) to automatically regulate the residence time(s) and therefore the specifications of the composted material(s).

Further aspects of the invention will become apparent from the following description, which is given by way of example only.

### DESCRIPTION OF THE DRAWINGS

An example of the invention will now be described with reference to the accompanying drawings in which:

FIG. 1 shows a perspective view from an inlet end of an example of continuous composting unit according to the invention with part of its sidewall removed to show the interior of the chamber;

FIG. 2 shows a perspective view of part of the outlet end of the composting unit shown in FIG. 1;

FIG. 3 shows by way of example a CAD perspective of a commercial composting unit according to the invention; and

FIG. 4 shows by way of example a side elevation view of a commercial installation of a composting unit according to the invention.

### DESCRIPTION OF THE PREFERRED EXAMPLES

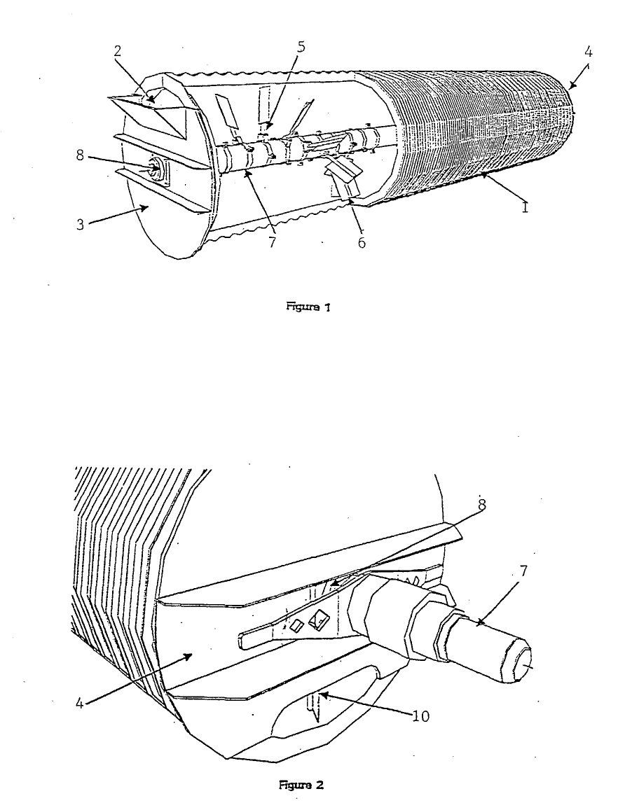

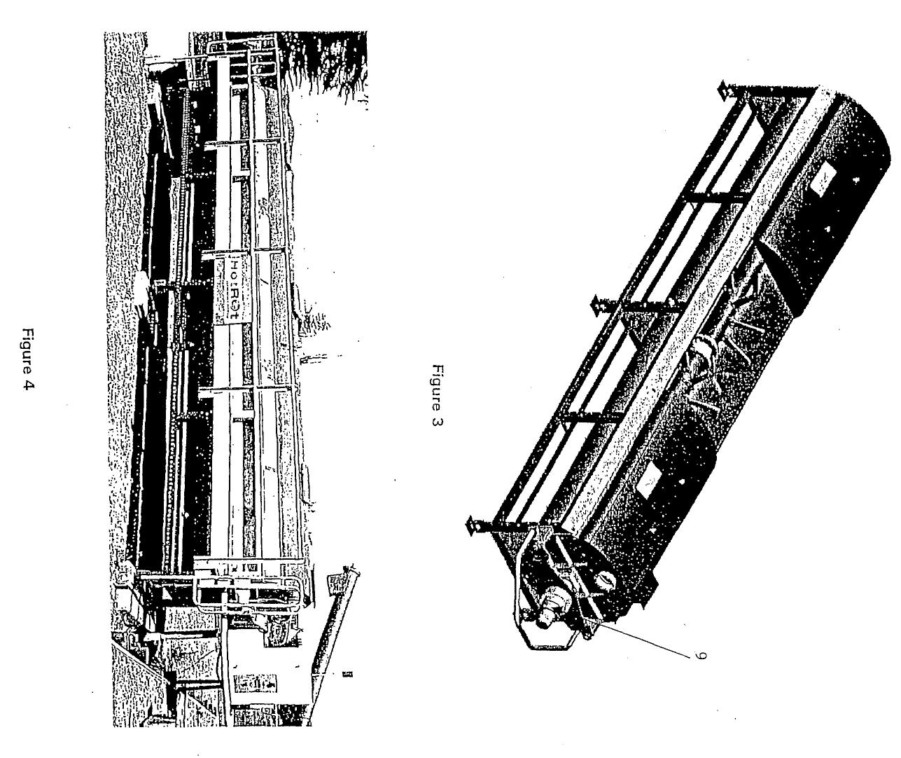

In the example shown in FIGS. 1 and 2 the chamber generally indicated by arrow 1 is unheated. The composting process generates heat and a requirement of the chamber's construction is that it minimises the loss of heat from the composting material. The chamber 1 can be constructed from material that can be metal (steel, iron, stainless steel, aluminium, etc), plastic, concrete or some composite material. There can be either an air gap between two skins or the chamber 1 can have an additional insulating material. Alternatively the chamber 1 may be made from a single layer of material, which is sufficiently rigid to maintain its shape while having good insulation properties in order to minimise the loss of heat generated during the composting process.

The material to be composted is fed in to a feed chute 2 at one end 3 of the composting chamber 1 via an auger/s, conveyor/s or manual system (loader, etc), (not shown). The composted material exits from the opposite and outlet end of the composting chamber 4 to either be collected in a container or fed directly onto a material transportation system (e.g. conveyor or auger, etc), (not shown). The chamber is mounted so that the bottom of the chamber rises slightly from the entrance to the exit. This is essential in order to avoid any leachate, formed during the composting process, re-contaminating the material exiting the system.

During its passage through the composting chamber 1 the mix will increase in temperature to in excess of 50° C. through the natural microbial action within the material. This is necessary to disinfect and stabilise the material. Alternatively, heat can be added from an external source to accelerate the process, or in instances where the composter is sited in a very cold climate.

Adequate aeration may be provided, simply though the movement of arms as described below. Air can be passed within a headspace of the chamber 1 (i.e. above the composting mix) in a direction counter-current to the movement of the compost material. In addition air can be forced through the material from ports (not shown) in the wall or base of the composting chamber 1 or ports in a shaft of the transport mechanism. The introduction of airflow aids in the removal of water from the system as steam and provides oxygen for the composting process.

The arms generally indicated by arrow 5 can consist of paddles, tines or some similar member 6 projecting from a shaft or shafts 7 into the outer area of the composting chamber 1. The arms 5 and the shaft/s 7 can be made of metal or plastic or some composite material (e.g. epoxy-fibreglass). Each shaft/s 7 is supported at each end by means of a bearing 8 in endplates 3′, 4′ fixed to the respective ends of the composting chamber 1.

The direction of airflow is generally counter-current to the direction of compost material flow. Forced aeration through the mass of composting material may also be necessary through ports (not shown) in the chamber wall on the underside of the compost mix, or through the central shaft or arms, and provided using a fan or compressed air system (not shown). The air speed through the system is controlled and is determined by the carbon dioxide content of the headspace and by the temperature of the air in the headspace of the composting unit. The air is removed via a single aperture at the feed end of the chamber, above the composting material and is either drawn via a fan, or ducted via a valve to the external atmosphere or to an odour-controlling device such as a biofilter (not shown).

In the example the shaft 7 runs both central and concentric to the chamber 1 and has a series of paddles 6 that are arranged in a single helix about the central shaft. The positioning and spacing of these arms is such that when the shaft is turned they move the material along the cylindrical chamber 1 of the compost unit. The material is moved by a drive mechanism either towards the exit or the feed direction, by rotating the shaft in opposite directions, can be reversed to allow for control of the residence time within the unit, while maintaining regular movement and therefore aeration of the composting mix. When moving the material toward an outlet 10 the arms 5 allow the material to be discharged through the outlet 10.

The composting unit is powered by a 3-phase electric motor directly coupled to a reduction gearbox 9 at the outlet end 4. Single-phase mains electricity or direct current electricity from solar cells, as well as hydraulic power packs, are other examples of possible power supplies which may be used to drive the drive mechanism. The drive mechanism may be mounted as a single system at either end of the shaft or may be configured as a dual drive system with a drive at both ends of the shaft/s.

In use, the operation of the composting system is controlled by a microprocessor-based controller (e.g. PLC or computer, etc). This controls the movement of the shaft and arms and therefore the residence time so that the composted material discharged from the outlet 10 in the end 4 of the chamber meets the required specifications in terms of odour, maturity and disinfection against pathogens. The controller also controls the feed and exit systems connected to the composting system in order to regulate the amount of material entering the system and to convey the material away from the outlet of the system.

The controller also controls the fan or valve, which regulates the air flowing through the system. The air flow rate is dictated by a combination of the carbon dioxide in the headspace of the compost unit and the temperature of the headspace. Generally the carbon dioxide level must be below 5% in the headspace to allow the growth of aerobic microbes within the mix. The fan speed is reduced when cold air outside causes the headspace to fall below a set temperature to a speed that allows the requirement for CO₂ concentration to be maintained.

Software, written for the express purpose, records the motor current to ensure that the specifications for the motor and gearbox are not exceeded. The PLC also records the temperatures of the compost mix, which is measured through a series of thermocouples mounted through the wall of the composting chamber and protruding into the mix. These may be mounted into the base or side of the chamber. Another thermocouple monitors the temperature of the headspace of the chamber. Another probe monitors the carbon dioxide content of the headspace. Temperature recording is important with respect to ensuring, and demonstrating, adequate disinfection for pathogens. The control system can be accessed, controlled and interrogated from a remote site. A centralised control system may be used to control a number of units on a single site or a number of units on a number of sites. The data collected by the control system can automatically be collated and fed back to the composting operators. It may also be used to automatically regulate the composting systems operation to ensure that the compost meets the required specifications

Where in the description particular mechanical integers are described it is envisaged that their mechanical equivalents can be substituted as if they were mentioned herein.

A particular example of the invention has been described and it is envisaged that improvements and modifications can take place without departing from the scope thereof.

1. A composting system including a generally horizontal composting chamber constructed as a covered channel which is fully enclosed or a substantially cylindrical vessel, the chamber being adapted so that air emissions from within the chamber can be controlled, the chamber including an internal transport system which conveys composting material from one end of the chamber to the other in a continuous or batch process, the transport system is based on a generally central shaft, or series of shafts generally about the centre of the chamber which have a series of discrete arms that extend into the outer volume of the chamber, the discrete arms being arranged about the shaft(s) such that when the shaft(s) are rotated they move the material in one direction or the other along the chamber, depending on the direction of rotation of the shaft(s), the transport system being under the control of a microprocessor based system which can use inputs from various probes about the chamber to determine the optimal operating parameters, such as air speed as a function of the headspace air temperature, or carbon dioxide or other gas content of the air in the chamber, so that the CO₂ or other gas content of the air is maintained at an optimal level.

2. A compost system as in claim 1 where the microprocessor records the inputs from various probes about the chamber.

3. A composting system as claimed in claim 1 or claim 2 wherein the chamber is constructed from a single insulating and structurally sound material or from two or more layers of material, at least one of which provides insulation.

4. A composting system as claimed in claim 2 or claim 3 wherein the chamber is unheated and the efficacy of the system relies on controlling the heat naturally produced in the composting process.

5. A composting system as claimed in claim 2 or claim 3 wherein the chamber is provided with heat from an additional source.

6. A composting system as claimed in any one of the preceding claims wherein the discrete arms are tines or paddles or other appendages which are arranged in a helical fashion about the shaft(s) such that when the shafts(s) are rotated they move the material in one direction or the other along the chamber, depending on the direction of rotation of the shaft(s),

7. A composting system as claimed in any one of the preceding claims wherein the transport system is operated by a drive mechanism, which can be either a single system at one end of the shaft(s) or a dual system with a drive at each end of the shaft(s).

8. A composting system as claimed in claim 7 wherein the drive system can be an electric motor(s) coupled to a reduction gearbox/es.

9. A composting system as claimed in claim 8 wherein the electric motor is powered by single- or three-phase mains electricity or direct current electricity from solar cells.

10. A composting system as claimed in claim 7 wherein the drive mechanism is a hydraulic drive system(s).

11. A composting system as claimed in any one of the preceding claims wherein the internal transport system is designed so that the appendages serve to mix the incoming composting material, to break up any agglomerates within the material and “fold” air into the composting material.

12. A composting system as claimed in claim 1 which is run as a batch process by filling the chamber and then equalising the movement of the shaft(s) in the opposing directions and by closing off the exit end of the system.

13. A composting system as claimed in claim 12 where the combinations of movement in opposite directions of the internal transport system serve to control the residence time of the material within the chamber and therefore maintain the specifications of the material exiting from the system.

14. A composting system as claimed in any one of claims 1 to 11 where the material can be fed in continuously or semi-continuously at one end and ejected at the other end of the chamber with the required residence time.

15. A composting system as claimed in any one of the preceding claims where in addition to the air introduced into the mix via the transport system, air is also drawn over the mix in a direction counter to the general flow of the material to avoid re-infection of the composted material by pathogens contained within the unprocessed feed material and to avoid reintroducing moisture into the composted material from steam being conducted by the airflow.

16. A composting system as claimed in claim 15 where the air is removed at the feed end of the chamber, and is either ejected via a fan or ducted via a valve to the external atmosphere or to an odour-controlling device such as a biofilter.

17. A composting system as claimed in claim 15 or claim 16 where additional air is injected into the composting material through the base of the chamber or through the shaft/s.

18. A composting system as claimed in any one of the preceding claims wherein the chamber is installed such that the exit end is higher than the inlet end with a minimum gradient of 1.100.

19. A composting system as claimed in any one of the preceding claims wherein a feed system is used to present the material to be composted to the inlet of the chamber and another system used to remove the compost from the exit area of the chamber.

20. A compost system as claimed in claim 19 wherein the feed system can be an auger(s) or conveyor(s).

21. A compost system as claimed in claim 19 or claim 20 wherein the exit system can be an auger(s) or conveyor(s) or a bin that is regularly emptied via other means.

22. A composting system as claimed in any one of the preceding claims which is incorporates a number of probes through the exterior of the chamber and extending into the headspace of the chamber, or into the composting mix, in order to measure temperature and carbon dioxide levels within the chamber.

23. A composting system as claimed in claim 22 wherein the carbon dioxide content of air in the chamber is maintained at a level of less than 5%.

24. A composting system as claimed in claim 23, which is controlled by a microprocessor based system, such as a PLC or computer, with data recording capabilities.

25. A composting system as claimed in claim 23 wherein the microprocessor based system incorporates software written for the specific purpose which records the input from the various probes about the chamber.

26. A composting system as claimed in claim 23 or claim 24 which monitors the current of the drive motor(s) to ensure that the torque of the transport system does not exceed the specifications of the transport system and drive mechanism and this system controls the movement and direction of the internal transport system and in-feed system to the compost and optionally it can control any exit system used to convey the material away from the chamber.

27. A composting system as claimed in claim 25 wherein the microprocessor system also controls the air speed of the air flowing over the composting material by the control of the speed of a fan, or a valve.

28. A composting system as claimed in any one of the preceding claims wherein the control system is operated remotely using software expressly written for the purpose.

29. A composting system as claimed in claim 27 or claim 28 where the control system is operated remotely via a centralised system, which controls a number of sites, the centralised system can provide feedback on composting conditions to operators and it can using software expressly written for the purpose, use the parameters recorded from the chamber(s) to automatically regulate the residence time(s) and therefore the specifications of the composted material(s).

30. A composting system as claimed in claim 1 substantially as hereinbefore described with reference to the accompanying drawings.
